(19) United States
(12) Patent Application Publication
(10) Pub. No.: US 2023/0137824 A1
(43) Pub. Date: May 4, 2023

(54) SOLENOID VALVE

(71) Applicant: Robert Bosch GmbH, Stuttgart (DE)

(72) Inventors: Andreas Wallner, Gmunden (AT); Arthur Eberhart, Kirchdorf an der Krems (AT); Thomas Preuer, Ansfelden (AT)

(21) Appl. No.: 17/973,684

(22) Filed: Oct. 26, 2022

(30) Foreign Application Priority Data
Oct. 28, 2021 (DE) 102021212172.1

(51) Int. Cl. F16K 31/06

(52) U.S. Cl. CPC F16K 31/0675; F16K 31/0655

(57) ABSTRACT

A solenoid valve having a movable valve element (5) that is movable by an electromagnet (10), wherein the electromagnet (10) has a magnet pot (13) having a recess (14) in which a solenoid coil (12) fixed on a coil body (11) is arranged. A sealing element (15) is arranged on the coil body (11) or a sealing body (17) fixedly connected to the coil body (11), which sealing element seals the recess (14) of the magnet pot (13) from the outside.

### BACKGROUND OF THE INVENTION

The invention relates to a solenoid valve as is used, for example, in metering valves for metering gaseous or liquid fuel.

Solenoid valves having a movable valve element with which an outlet opening can be opened or closed are frequently used for metered delivery of gaseous or liquid fuels. The valve element is moved by an electromagnet that, when energized, moves the valve element against the force of a spring. Such a solenoid valve is known, for example, from DE 10 2015 212 476 A1. The valve element, which is designed here in the form of a plate, and which also forms the magnet armature, is moved against the force of a closing spring and opens an outlet opening through which the fuel, which is in this case gaseous, can flow out.

The electromagnet moving the valve element comprises a solenoid coil and a magnet body on which the solenoid coil is fixed. The magnet body, together with the solenoid coil, is arranged in a recess of a magnet pot. Said recess is cylindrical and open in the direction of the magnet armature in order to focus the magnetic field onto the magnet armature. Because the gaseous fuel flows around the magnet armature, the fuel also reaches the region of the magnet pot and thus the region of the solenoid coil. The permanent supply of the gaseous fuel or also of other fluid fuels can cause damage to the coil body or to the solenoid coil, which can impair the functionality of the electromagnet and thus of the solenoid valve over time.

### SUMMARY OF THE INVENTION

The solenoid valve according to the invention has the advantage of a longer service life because the solenoid coil and the coil body on which the solenoid coil is fixed is not acted upon by the gaseous or liquid fuel, and therefore the corresponding components cannot be damaged by the fuel. For this purpose, the solenoid valve has a movable valve element that is movable by an electromagnet, wherein the electromagnet has a magnet pot having a recess in which a solenoid coil fixed on a coil body is arranged. A sealing element is arranged on the coil body or a sealing body fixedly connected to the coil body, which sealing element seals the recess of the magnet pot from the outside.

The gaseous or liquid fuel flows around the valve element such that the fuel also reaches the region of the electromagnet and can damage the solenoid coil or the other components on the electromagnet in the long term. In particular the solenoid coil that is attached to the coil body and is fixed with a potting compound can be damaged as a result. The sealing of the corresponding recess in the magnet pot by a sealing body on the coil body is a simple and cost-effective solution that does not require any further sealing elements that would have to be mounted in a separate manufacturing step. The seal is thus produced with the installation of the solenoid coil in the magnet pot.

In a first advantageous embodiment, the recess has a cylindrical shape. Accordingly, the sealing element comprises a sealing ring that serves to seal the recess. Advantageously, the coil body is also cylindrical or annular and has an outer sealing ring on the outer side and an inner sealing ring on the inner side, which sealing rings seal the coil body against the wall of the recess. Such a coil body having the corresponding sealing rings can easily be introduced into the recess and thereby seals the recess without further process steps being necessary. In this case, the sealing rings are in each case arranged in an annular groove in the coil body or in a sealing body that is fixedly connected to the coil body.

The sealing element is advantageously designed such that it seals the recess in a gas-tight and/or liquid-tight manner from the outside. The sealing element or the sealing rings are made from an elastic polymer, for example rubber, or from another polymer, for example PTFE (polytetrafluoroethylene).

### BRIEF DESCRIPTION OF THE DRAWINGS

The drawings show a solenoid valve according to the invention. In the drawings:

FIG. 1 is a cross section through a solenoid valve according to the invention with an electromagnet,

FIG. 2 is an enlarged representation of the electromagnet according to the invention and

FIG. 3 is an enlargement of the section denoted by III in FIG. 2 of a further embodiment.

### DETAILED DESCRIPTION

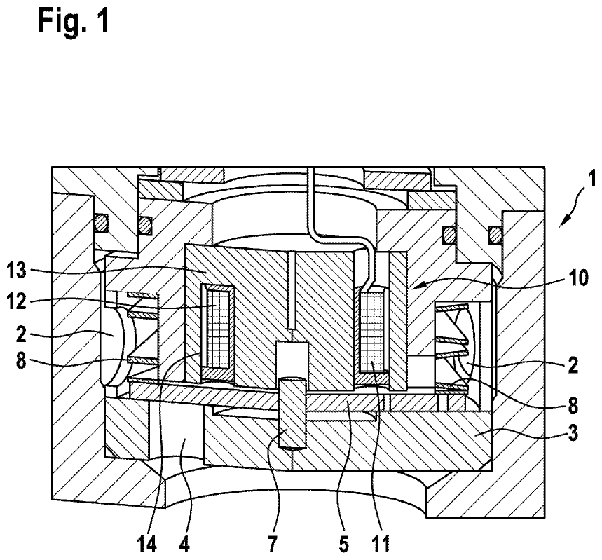

FIG. 1 shows a solenoid valve according to the invention in cross section. The solenoid valve comprises a housing 1 that has two inlet openings 2 for supplying the gaseous fuel. An outlet opening 4, via which the gaseous fuel exits the solenoid valve, is formed in a valve seat element 3. To control the flow, a plate-shaped valve element 5 is arranged above the valve seat element 3, which plate-shaped valve element interacts with the valve seat element 3 for opening and closing the outlet opening 4. In this case, the valve element 5 is radially guided on a guide pin 7 that is anchored in the valve seat element 3. The valve element 5 is pretensioned by a plurality of spring elements 8 against the valve seat element 3 and can be moved against the force of said spring elements 8 in the direction of the electromagnet 10 by means of actuation of an electromagnet 10. The electromagnet 10 is arranged in the housing 1 on the side of the valve element 5 opposite the valve seat element 3 and comprises a magnet pot 13 in which a cylindrical recess 14 is formed. A solenoid coil 12, which is fixed on a coil body 11, is arranged in the recess 14. By energizing the solenoid coil 12, a magnetic field is generated that is focused by the magnet pot 13 onto the valve element 5 and moves said valve element away from the valve seat element 3 counter to the force of the spring elements 8 such that the outlet opening 4 is released. If the energization of the solenoid coil 12 is interrupted, the spring elements 8 press the valve element 5 back into its closed position in contact with the valve seat element 3.

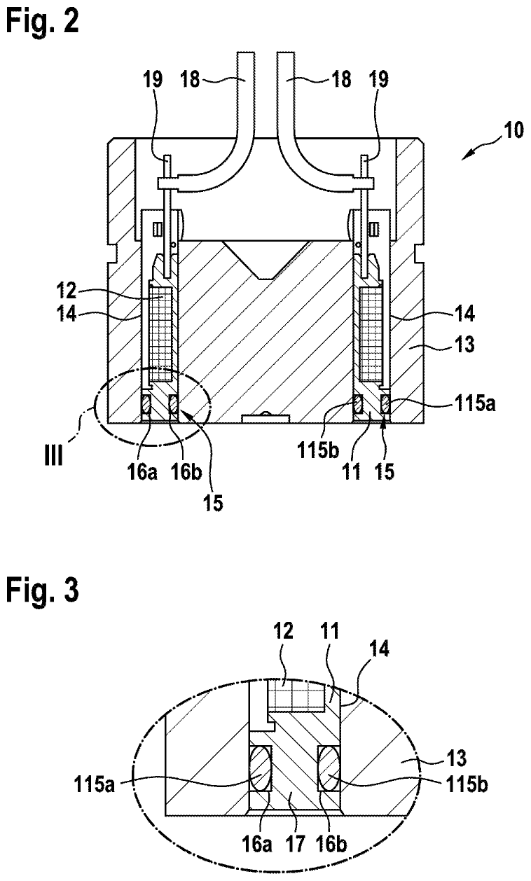

FIG. 2 is an enlarged representation of the electromagnet 10. The coil body 11 has a sealing element 15 on its end facing the valve element 5. The sealing element 15 is in this case in the form of two sealing rings, an outer sealing ring 115a and an inner sealing ring 115b. The outer sealing ring 115a is arranged in an outer annular groove 16a and the inner sealing ring 115b is arranged in an inner annular groove 16b, wherein the two annular grooves 16a, 16b are formed in the coil body 11 and seal the coil body 11 in a gas-tight manner against the inner wall of the recess 14. The contacting of the solenoid coil 12 is effected via connection wires 18 that are each fastened to a connection pin 19 and via which a coil current can be introduced into the solenoid coil 12.

The sealing element 15 or the sealing rings 115a, 115b are made from a polymer having sufficient elasticity to bring about a gas-tight sealing of the recess 14. The sealing rings 115a, 115b can be manufactured from a polymer, for example an elastomer or some other plastics material. In particular, the sealing rings 115a, 115b can be made from PTFE (polytetrafluoroethylene) because this plastics material has a high chemical resistance.

FIG. 3 is an enlarged representation of the section denoted by III in FIG. 2 of a further embodiment. The sealing element 15 is in this case not formed directly in the coil body 11, but in a sealing body 17 that is fixedly connected to the coil body 11, for example by means of a welded connection. As a result, the sealing body 17 can be manufactured separately and connected to the coil body 11 before the installation of the electromagnet 10, such that the coil body 11, the solenoid coil 12 and the sealing body 17 can subsequently be introduced into the recess 14 together. The sealing element 15 then closes the recess 14 such that the solenoid coil 12 and the coil body 11 are sealed with respect to the gaseous fuel in the housing 1.

What is claimed is:

1. A solenoid valve having a movable valve element (5) that is movable by an electromagnet (10), wherein the electromagnet (10) has a magnet pot (13) having a recess (14) in which a solenoid coil (12) fixed on a coil body (11) is arranged, wherein a sealing element (15) is arranged on the coil body (11) or a sealing body (17) fixedly connected to the coil body (11), which sealing element seals the recess (14) of the magnet pot (13) from the outside.

2. The solenoid valve according to claim 1, wherein the recess (14) has a cylindrical shape.

3. The solenoid valve according to claim 2, wherein the sealing element (15) comprises a sealing ring (115a; 115b).

4. The solenoid valve according to claim 3, wherein the sealing ring is arranged in an annular groove (16a; 16b) in the coil body (11) or in the sealing body (17).

5. The solenoid valve according to claim 3, wherein the sealing ring (115a; 115b) is made from a polymer.

6. The solenoid valve according to claim 3, wherein the sealing ring (115a; 115b) is made from an elastomer or some other plastics material.

7. The solenoid valve according to claim 3, wherein the sealing ring (115a; 115b) is made from PTFE.

8. The solenoid valve according to claim 2, wherein the coil body (11) has a substantially annular shape and the sealing element (15) comprises an outer sealing ring (115a) arranged on an outer side of the coil body and an inner sealing ring (115b) arranged on an inner side of the coil body, wherein the inner and outer sealing rings seal the coil body (11) against walls of the recess (14).

9. The solenoid valve according to claim 8, wherein the inner and outer sealing rings (115a; 115b) are each arranged in an annular groove (16a; 16b) in the coil body (11) or in the sealing body (17).

10. The solenoid valve according to claim 8, wherein the inner and outer sealing rings (115a; 115b) are made from a polymer.

11. The solenoid valve according to claim 8, wherein the inner and outer sealing rings (115a; 115b) are made from an elastomer or some other plastics material.

12. The solenoid valve according to claim 8, wherein the inner and outer sealing rings (115a; 115b) are made from PTFE.

13. The solenoid valve according to claim 1, wherein the sealing element (15) is made from a polymer.

14. The solenoid valve according to claim 1, wherein the sealing element (15) is made from an elastomer or some other plastics material.

15. The solenoid valve according to claim 1, wherein the sealing element (15) is made from PTFE.

16. The solenoid valve according to claim 1, wherein the sealing element (15) seals the recess (14) in a gas-tight and/or liquid-tight manner from the outside.

17. A solenoid valve having a movable valve element (5) that is movable by an electromagnet (10), wherein the electromagnet (10) has a magnet pot (13) having a recess (14) in which a solenoid coil (12) fixed on a coil body (11) is arranged, wherein a sealing element (15) is arranged on the coil body (11), which sealing element seals the recess (14) of the magnet pot (13) from the outside.

18. The solenoid valve according to claim 17, wherein the recess (14) has a cylindrical shape, and wherein the sealing element (15) comprises a sealing ring (115a; 115b) arranged in an annular groove (16a; 16b) in the coil body (11) or in the sealing body (17).

19. A solenoid valve having a movable valve element (5) that is movable by an electromagnet (10), wherein the electromagnet (10) has a magnet pot (13) having a recess (14) in which a solenoid coil (12) fixed on a coil body (11) is arranged, wherein a sealing element (15) is arranged on a sealing body (17) fixedly connected to the coil body (11), which sealing element seals the recess (14) of the magnet pot (13) from the outside.

20. The solenoid valve according to claim 19, wherein the recess (14) has a cylindrical shape, and wherein the sealing element (15) comprises a sealing ring (115a; 115b) arranged in an annular groove (16a; 16b) in the sealing body (17).
